(19) United States
(12) Patent Application Publication
(10) Pub. No.: US 2025/0119780 A1
(43) Pub. Date: Apr. 10, 2025

(54) MEASUREMENT BEFORE RADIO LINK FAILURE

(71) Applicant: Apple Inc., Cupertino, CA (US)

(72) Inventors: Yuqin Chen, Beijing (CN); Fangli Xu, Beijing (CN); Haijing Hu, Los Gatos, CA (US)

(73) Assignee: Apple Inc., Cupertino, CA (US)

(21) Appl. No.: 18/871,989

(22) PCT Filed: Oct. 31, 2022
(86) PCT No.: PCT/CN2022/128701

§ 371 Date: Dec. 5, 2024

(30) Foreign Application Priority Data
Aug. 9, 2022 (WO) PCT/CN2022/111166

(51) Int. Cl. H04W 24/10; H04B 17/318; H04W 84/06

(52) U.S. Cl. CPC H04W 24/10; H04B 17/328; H04W 84/06

(57) ABSTRACT

The present application relates to devices and components including apparatus, systems, and methods for performing measurements before a radio link failure. In an example, a condition is detected by a UE in advance of a time point in which a non-terrestrial network (NTN) node is to stop providing service to the UE. The condition can be a timing-based condition related to, for example, t-service, a location-based condition related to, for example, a reference location, a coverage hole, and/or a timer condition. The UE can perform, in advance of the time point, a radio resource management (RRM) measurement in an attempt to measure a neighbor cell based on the condition.

### REFERENCE TO RELATED APPLICATION

The present application claims priority to Patent Application Number PCT/CN2022/111166, “Measurement Before Radio Link Failure,” filed on Aug. 9, 2022, which is incorporated herein by reference in its entirety.

### TECHNICAL FIELD

This application relates generally to wireless communication systems, and in particular relates to measurement before radio link failure.

### BACKGROUND

Third Generation Partnership Project (3GPP) Technical Specifications (TSs) define standards for wireless networks. These TSs describe aspects related to a user equipment measuring neighbor cells for mobility purposes.

### BRIEF DESCRIPTION OF THE DRAWINGS

FIG. 1 illustrates a network environment in accordance with some embodiments.

FIG. 2 illustrates a timing diagram in accordance with some embodiments.

FIG. 3 illustrates an example of non-terrestrial network (NTN) coverage, in accordance with some embodiments.

FIG. 4 illustrates coverage scenarios in accordance with some embodiments.

FIG. 5 illustrates a timing-based radio resource management (RRM) measurement in accordance with some embodiments.

FIG. 6 illustrates a location-based RRM measurement in accordance with some embodiments.

FIG. 7 illustrates a network coverage hole-based RRM measurement in accordance with some embodiments.

FIG. 8 illustrates a timer-based RRM measurement in accordance with some embodiments.

FIG. 9 illustrates an example of an operational flow/algorithmic structure implemented for managing performance of RRM measurement, in accordance with some embodiments.

FIG. 10 illustrates a user equipment in accordance with some embodiments.

FIG. 11 illustrates a base station in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

Embodiments of the present disclosure relate to managing performance of a measurement, such as radio resource management (RRM) measurement, prior to a radio link failure (RLF). In an example, a serving cell of a user equipment (UE) is provided by a non-terrestrial network (NTN) node, such as a satellite in the case of satellite-based communications (although non-satellite NTNs may be possible). In advance of a time point in which the NTN node is to stop providing service to the UE, the UE can determine that a set of conditions is satisfied to perform an RRM measurement. Accordingly, the UE performs, in advance of the time point, the RRM measurement in an attempt to measure a neighbor cell based on the condition. The neighbor cell can be a terrestrial network (TN) cell or another NTN cell. The time point can be determined based on timing information and/or location information received from a network. The network can also configure the UE with information about the cell(s) that need to be measured. By doing so, the UE can avoid attempting to perform the RRM measurement when unneeded, thereby improving its overall power consumption. These and other features are further described herein below.

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

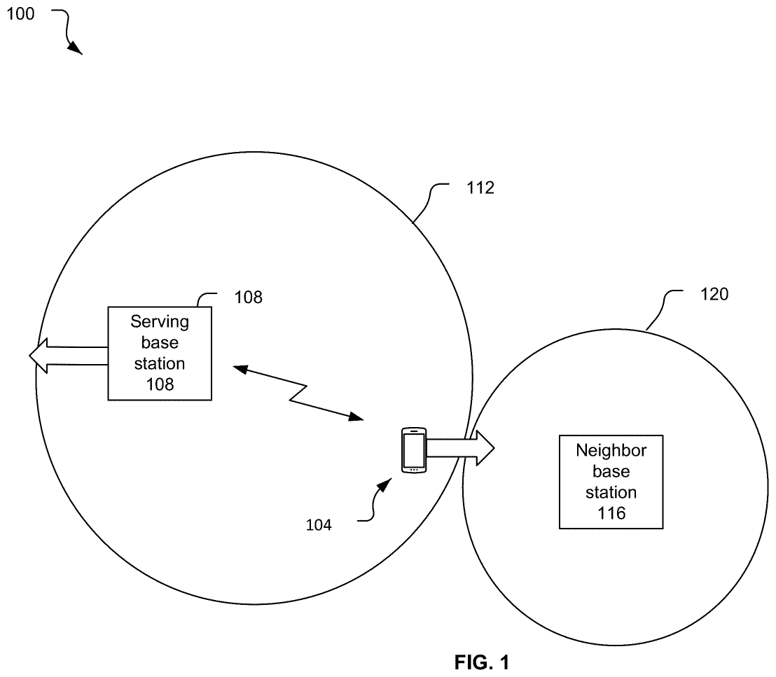

FIG. 1 illustrates a network environment 100 in accordance with some embodiments. The network environment 100 may include a user equipment (UE) 104 communicatively coupled with a serving base station 108 of a radio access network (RAN). The serving base station 108 may provide a serving cell 112.

The UE 104 and the base station 108 may communicate over air interfaces compatible with 3GPP TSs such as those that define Long Term Evolution (LTE), Fifth Generation (5G) new radio (NR), or a later system. The base station 108 may provide user plane and control plane protocol terminations toward the UE 104 through a serving cell 112.

The network environment 100 may further include a neighbor base station 116 that provides a neighbor cell 120.

In some instances, a connection the UE 104 has with the serving base station 108 may deteriorate. This may be based on relative movement between the UE 104 and the serving base station 108. For example, the UE 104 may move away from the serving base station 108, or the serving base station 108 may move away from the UE 104. The latter scenario may occur if the serving base station 108 is, for example, a satellite of a non-terrestrial network (NTN).

To avoid a radio link failure (RLF) based on a deteriorating connection, the UE 104 may attempt to reestablish a radio resource control (RRC) connection with the neighbor cell 120. To do so, the UE 104 may perform an RRM measurement as part of a cell search, cell selection, cell re-selection, handover, and the like. The RRM measurement can include different types of measurements indicating a channel quality, such as a reference signal received power (RSRP) measurement, a narrowband RSRP (NRSRP), etc. as part of intra-frequency measurement, inter-frequency measurements, and/or inter-RAT measurements.

In some embodiments, the UE 104 may be a narrowband-Internet of things (NB-IoT) UE, which may have a relatively long latency for RRC reestablishment.

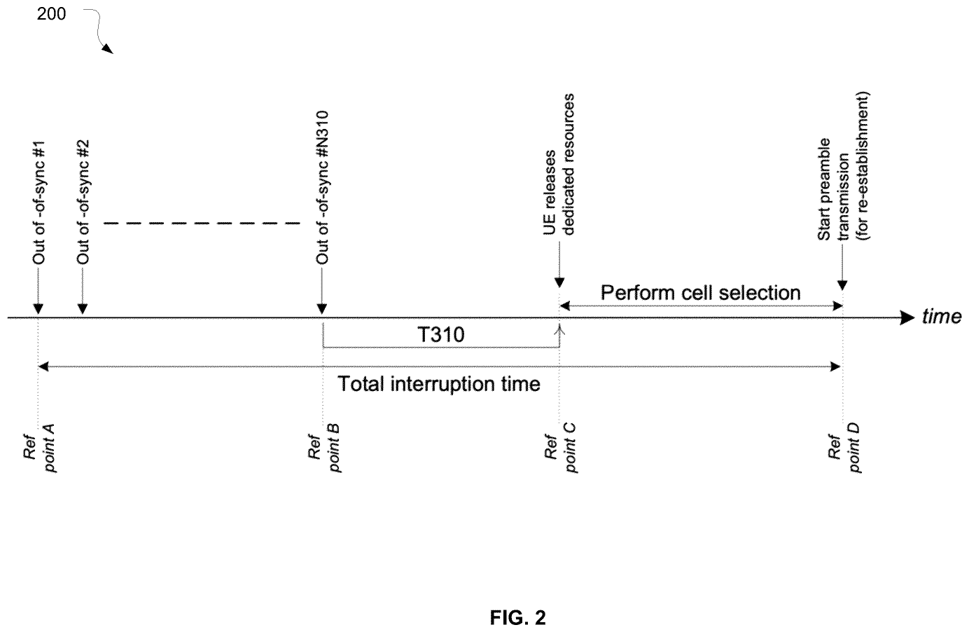

FIG. 2 illustrates an overview of RLF and RRC reestablishment 200 in accordance with some embodiments. The relatively long latency for RRC reestablishment of an NB-IoT UE may be between reference point A and reference point D, which may be due to an NB-IoT UE not supporting mobility in an RRC connected state (for example, no measurement reports, no handover, etc.), or due to the relatively long time (e.g., hundreds of milliseconds) to perform a cell selection after an RLF declaration.

The relatively long latency relates to various operations/configurations associated with pre-release 17 (R17) NB-IoT UEs compatible with LTE. For example, pre-R17 NB-IoTs had no provision of neighbor frequency/cell information, and the UE would need to determine the frequency/cell to measure itself. In another example, the NB-IoT UEs would not perform neighbor cell measurement or provide a measurement report. In yet another example, the NB-IoT UEs would not do a handover, rather, they would perform RRC reestablishment instead.

Typically, a UE, such as an NB-IoT UE compatible with LTE, would only perform a connected state measurement when two conditions are met. The first condition may correspond to a timer (T3xx/T326) running and a second condition may correspond to a serving cell quality threshold.

Timer T3xx (T326) may be triggered due to transition to connected state and relaxed monitoring criteria is not fulfilled, or fast variance of the serving cell quality if neighCellMeasCriteria is configured. The fast variance can be determined using t-MeasureDeltaP and s-MeasureDeltaP. MeasureDeltaP is the time duration where UE performs RRM when neighborCellMeasCriteria (channel quality variance) is configured. s-MeasureDeltaP is a threshold configuration on variance of serving cell quality (neighCellMeasCriteria). As far as the serving cell quality (second condition), a threshold configuration on serving cell quality may be determined based on s-MeasureIntra for intra-frequence measurement or s-MeasureInter for inter-frequency measurement. These conditions can be defined as following (e.g., as an addition to 3GPP TS 136.304, V17.2.0 (October 2022)):
5.5.x Measurements in NB-IoT
Upon transition to RRC CONNECTED mode, the UE shall:
   1> if neighCellMeasCriteria is present in SystemInformationBlockType 3-NB:
      2> set NRSR_{Ref} to the latest result of the serving cell measurement as used for cell selection/reselection evaluation;
      2> if the relaxed monitoring criterion defined in TS 36.304 [4] was not fulfilled:
   3> start T3XX with the value f-MeasureDeltaP;
While in RRC_CONNECTED mode, after performing a measurement, the UE shall:
   1> in the following use the NRSRP measurement for the measured carrier and nrs-PowerOffsetNonAnchor corresponding to the measured carrier;
   1> if neighCellMeasCriteria is present in SystemInformationBlock Type 3-NB:
   2> if (NRSRP_{Ref}-(NRSRP-PowerOffsetNonAnchor))>s-Measure DeltaP:
      3> set NRSRP_{Ref}=(NRSRP-nrs-PowerOffsetNonAnchor);
      3> start or restart T3XX with the value t-MeasureDeltaP;
   1> if neighCellMeasCriteria is not present in SystemInformationBlock Type 3-NB; or
   1> if T3XX is running:
      2> if (NRSRP-nrs-PowerOffsetNonAnchor)<s-MeasureIntra, perform intra-frequency measurements as defined in TS 36.133 [161]
      2> if (NRSRP-nrs-PowerOffsetNonAnchor) s-MeasureInter, perform inter-frequency measurements as defined in TS 36.133 [16].

The above conditions and changes can be defined for an NB-IoT UE when served by a terrestrial network (TN) node. However, service by a non-terrestrial network (NTN) node needs to consider other factors, as further described in the next figures.

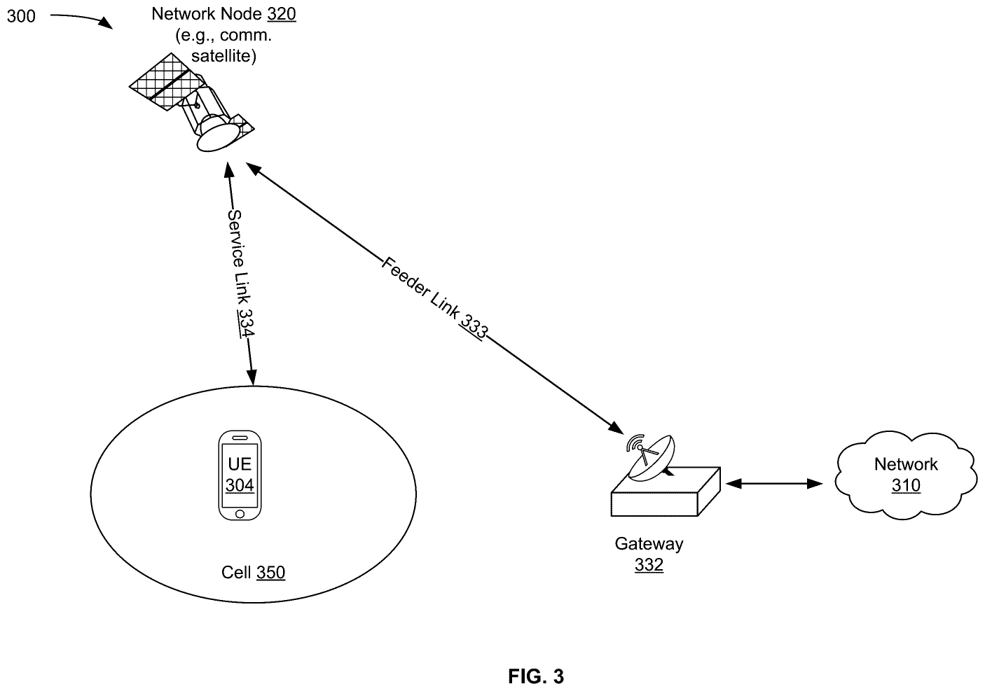

FIG. 3 illustrates an example of non-terrestrial network (NTN) coverage 300, in accordance with some embodiments. A network 310 can be accessible to UEs via a network node 320 that supports multiple cells. Each cell corresponds to a coverage area within which the NTN coverage 300 is available. The network coverage 300 can be discontinuous across the coverage areas due to different factors including movement of the network node 320, redirection of the beams that provide the cells, movement of the UE 304 to be an area not covered by the network coverage 300, etc. For instance, the network coverage 300 may be available in a first cell for some time interval, while being unavailable in a second cell during that same time interval. During a different time interval, the network coverage 300 may no longer be available in the first cell, while being available in the second cell.

In an example, the network 310 can implement a particular set of radio access technologies (RATs) such as, but not limited to, LTE and/or different generation of a 3GPP network. The network 310 can also be a terrestrial network, in which case the network node 320 can be a terrestrial access node, such as an eNB (or, more generally a terrestrial base station). In another example, the network 310 can be, at least in part, a non-terrestrial network where the network node 320 may be implemented on a communications satellite. In this case, the network node 320 may be referred to as a non-terrestrial base station and may be coupled with the ground network via a gateway 332.

Generally, the network node 320 can cover a large geographical area, where this area can be divided in a large number of cells (potentially in the hundreds, if not thousands). A UE 304 can be located within a cell (show as the cell 350 in FIG. 3) and can connect with the network node 320 via a feeder link 324. In this way, the UE 304 can have access to the network 310 via the network node 320.

The NTN coverage 300 can change geographically over time. For example, during certain time intervals, the network coverage 300 is available to the UE 304 located in the cell 350. During other time intervals, the network coverage 300 is unavailable to the UE 304 at the same location, whereby the NTN 320 may stop providing service of the cell 350 in that location.

In the interest of clarity of explanation, various embodiments are described hereinafter in connection with a communications satellite as an example of the network node 320. Further, these various embodiments are described in connection with a device that has a narrowband internet of things (NB-IoT) configuration. However, the embodiments are not limited as such and similarly apply to any other base station that belongs to a network providing a discontinuous network coverage and/or to any other device to which the discontinuous network coverage may be provided. Furthermore, causes of the discontinuous network coverage can be due to a number of factors, such as any or a combination of the repositioning of the communications satellite (e.g., in the case of a moving cell), changes to the beam direction, and/or changes to a device's position (e.g., in the case of quasi-Earth fixed cell, where the device may be re-located from a coverage area of a cell to a geographical area where the network coverage is not available). The embodiments apply to any situations where such discontinuous network coverage occurs.

For NTN networks, quasi-Earth fixed cell scenarios can be described in association with reference locations and threshold distances. Generally, location information refers to the reference location of a serving cell (ReferenceLocation). If the distance between a UE and ReferenceLocation is greater than or equal to a threshold distance (distance Thresh), the UE shall perform intra-frequency measurement, inter-frequency measurements, or inter-RAT measurements.

For NTN networks, quasi-Earth fixed cell scenarios can also be described in association with time-based cell selection/reselection measurement. Timing information (e.g., t-service) refers to the time when the serving cell (e.g., an NTN serving cell, such as the cell 350 of FIG. 3) is going to stop serving a geographical area. If t-service of the serving cell is present in system information block (SIB) 19, the UE shall perform intra-frequency, inter-frequency or inter-RAT measurements before t-service. The exact time to start measurement before t-service can be up to UE implementation.

Efforts are ongoing to specify further enhancements for evolved universal terrestrial access (E-UTRA) (LTE-RAN) based NTN according to the following assumptions: geosynchronous orbit (GSO) and non-geosynchronous orbit (NGSO) (low-Earth orbit (LEO) and medium Earth orbit (MEO)); Earth fixed tracking area (Earth fixed & Earth moving cells for NGSO); frequency division duplexing (FDD) mode; and UEs with GNSS capabilities.

Objectives for these efforts include: IoT-NTN performance Enhancements in to address R17-related issues (disabling of HARQ feedback to mitigate impact of HARQ stalling on UE data rates; study and specify, if needed, improved GNSS operations for a new position fix for UE pre-compensation during long connection times and for reduced power consumption). R17 IoT-NTN work and R17 new radio (NR)-NTN outcome can be considered as a baseline; Mobility enhancements (support of neighbor cell measurements and corresponding measurement triggering before RLF, using R17 TN NB-IoT, enhanced machine type communication (eMTC) as a baseline; and re-use the solutions introduced in R17 NR NTN for mobility enhancements for eMTC, with minimum necessary changes to adapt them to eMTC); and further enhancement to discontinuous coverage.

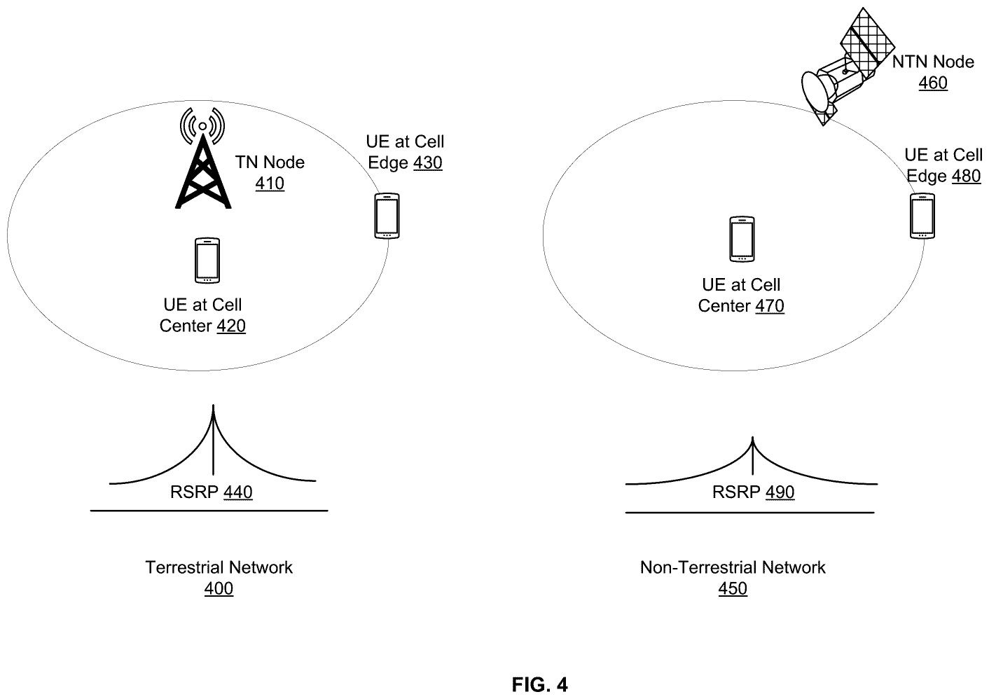

As part or despite such efforts, different challenges exist. For example, a quasi-fixed Earth cell stops serving after t-service so the RLF may be caused by the satellite movement. The NTN cell signal does not degrade drastically, compared to TN cell. Thus, the RSRP may be still good when UE moves to the cell edge of NTN cell (e.g., see comparative diagram 400 of FIG. 4). The NTN cell may have more coverage holes where UE should avoid fast RRC Reestablishment. If no neighbor NTN/TN cell is available, long RRM only leads to UE power consumption.

Various embodiments of the present disclosure address some or all of the above challenges and/or other challenges. Some factors considered with respect to the embodiments may include that the UE moving speed is negligible compared to satellite movement speed, and the serving cell channel quality can be very good when UE moves to the cell edge.

FIG. 4 illustrates coverage scenarios in accordance with some embodiments. On the left hand side of FIG. 4, the coverage of a terrestrial network 400 is shown. In particular, a TN node 410 (e.g., a TN eNB) provides a cell. The cell's coverage is shown with the elliptical boundary, where service is available to a UE located within the elliptical boundary. In the illustration of FIG. 4, when the UE is at the cell center 420, the UE can have the highest RRM measurement (e.g., such as a peak of an RSRP measurement 440). When the UE is at the cell edge 430, the RRM measurement is relatively much smaller.

On the right hand side of FIG. 4, the coverage of a non-terrestrial network 450 is shown. In particular, an NTN node 460 (e.g., an NTN eNB) provides a cell. The cell's coverage is also shown with the elliptical boundary, where service is available to a UE located within the elliptical boundary. In the illustration of FIG. 4, when the UE is at the cell center 470, the UE can have the highest RRM measurement (e.g., such as a peak of an RSRP measurement 490). When the UE is at the cell edge 430, the RRM measurement is relatively much smaller.

The RRM measurement behavior (e.g., its distribution depending on a UE's location relative to a cell center) can vary substantially depending on whether TN or NTN coverage is provided. For example, when comparing the RSRP measurement 440 to the RSRP measurement 490, it can be seen that the RSRP peak is relatively larger in the TN coverage use case. The RSRP value also degrades at a relatively higher rate as the UE approaches the cell edge in the TN coverage use case. Because of the differences, conditions defined for TN coverage (e.g., conditions for TN NB-IoT UE as in FIG. 2) may not be proper for NTN coverage.

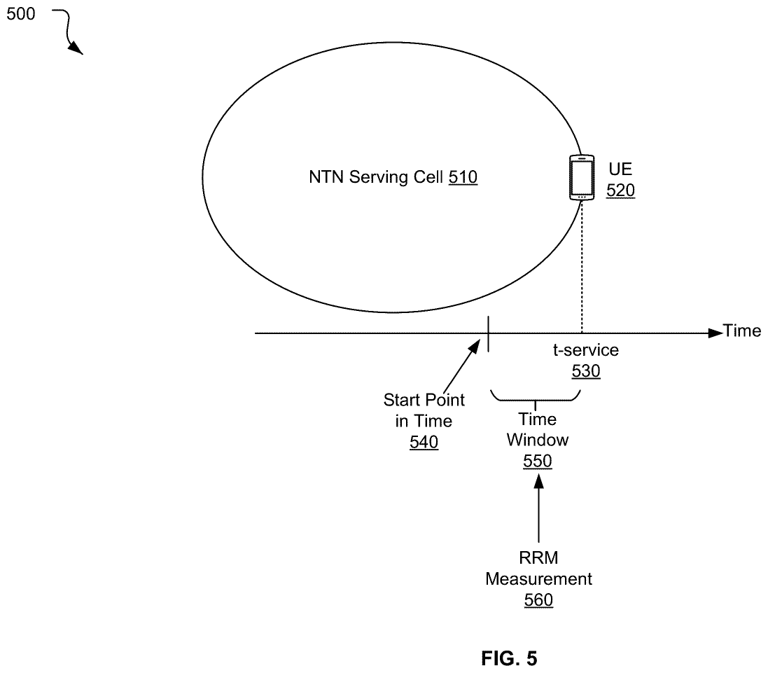

FIG. 5 illustrates a timing-based RRM measurement 500 in accordance with some embodiments. As illustrated, a UE 520 is connected to an NTN serving cell 510 of an NTN node (e.g., an NTN eNB implemented on a satellite) such that the UE 520 has NTN coverage. The NTN serving cell 510 can move relative to the UE 520 and/or the UE 520 can move relative to the NTN 510. In both cases, the NTN coverage changes over time. After a certain point in time, shown as t-service 530, the network NTN coverage may become unavailable to the UE 520 from the NTN done (where “unavailable” can refer to the NTN coverage being non-existent, or having a channel quality smaller than a first predetermined threshold and a variance (or variation) larger than a second predetermined threshold). In the illustration of FIG. 5, at t-service 530, the UE 520 may be located at or near the edge of the NTN service cell 510 (although other relative locations may also be possible at t-service 530). In advance of the point in time (e.g., t-service 530), the UE may start to perform an RRM measurement. This RRM measurement can include intra-frequency measurement, inter-frequency measurement, and/or inter-RAT measurement for a neighbor NTN cell (e.g., provided by the same or a different NTN node) and/or a neighbor TN cell.

In some embodiments, the t-service 530 can be a t-service of a satellite. In such a situation, a network (e.g., the network 310 of FIG. 3), such as a component thereof, can indicate the value of the t-service 530 to the UE 520. For example, system information block (SIB) message, such as a SIB3-NB message, can be sent to the UE and can include information indicating this value. The UE 520 may start to perform neighbor NTN/TN cell measurement before t-service 530. Different options exist for when the UE 520 can start to perform such measurements.

In a first option, the network may configure the exact time point when the UE 520 is to start the RRM measurement before t-service 530. For example, the SIB3-NB indicates the value of this exact time point (shown in FIG. 5 as “start point in time” 540). Additionally, or alternatively, the network may configure a time window 550 during which the UE can start or needs to perform the RRM measurement. This time window 550 can end at or before t-service 530. In the illustration of FIG. 5, the time difference between t-service 530 and the start point in time 540 corresponds to the time window 550. As such, at the start or some time during the time window 550, the UE 520 can perform an RRM measurement 560.

In a second option, the timing may not be configured by the network. Instead, the exact time point or time window may be up to implementation of the UE 520.

The network may provision t-service 530 (for example, the time point a current satellite stops serving the UE 520) to the UE 520 for the NTN serving cell 510. This provisioning can involve sending one or more SIB messages (e.g., SIB3-NB message(s)).

The UE 502 may decide which satellite (or which cell) to measure based on other network-configured information. For example, one or more SIB 32 messages can be used for NB-IoT can indicate ephemerisOrbitalParameters (e.g., information related to the position of a satellite) and t-service of neighbor NTN cells. If a neighbor NTN cell is not available (e.g., during the time window 550), the UE 502 may skip the RRM measurement 560.

The UE 520 may also decide which TN cell and/or frequency to measure based on the configured frequencies and/or cells. Such configuration information can also be available from SIB messages including, for example, one or more SIB4-NB messages usable for indicating intra-frequency neighbor cell measurements and/or one or more SIB5-NB messages usable for indicating inter-frequency neighbor cell measurements.

In some embodiments, the UE 502 may start performing neighbor NTN/TN cell measurement when conditions, additional to the timing-based condition described herein above, are met. These conditions may include: a channel quality of the NTN serving cell 510 being smaller than a predetermined threshold (e.g., as in the second condition discussed in FIG. 2) and a channel quality variance is fast (e.g., as in the first condition discussed in FIG. 2), in addition to determining that the t-service 530 is approaching (as discussed above in FIG. 5).

Some embodiments may include an enhancement on a prioritization order of frequencies during RRM for NB-IoT. For example, the network may indicate which frequency and/or cell (NTN or TN) is prioritized when the UE 520 performs RRM measurement on neighbor cells. The UE 520 may follow the prioritization configuration of neighbor frequencies in a SIB when performing RRM measurement. For example, the network may configure the priority for each frequency and/or cell (e.g., by using a priority index). Based on this configuration, the UE 520 can determine the set of frequencies and/or cells that have a higher priority relative to a priority associated with the NTB serving cell 510 and continuously perform RRM measurements. In comparison, the UE 520 can determine the set of frequencies and/or cells that have a lower priority relative to a priority associated with the NTB serving cell 510 and perform RRM measurements when the above conditions are determined to be satisfied.

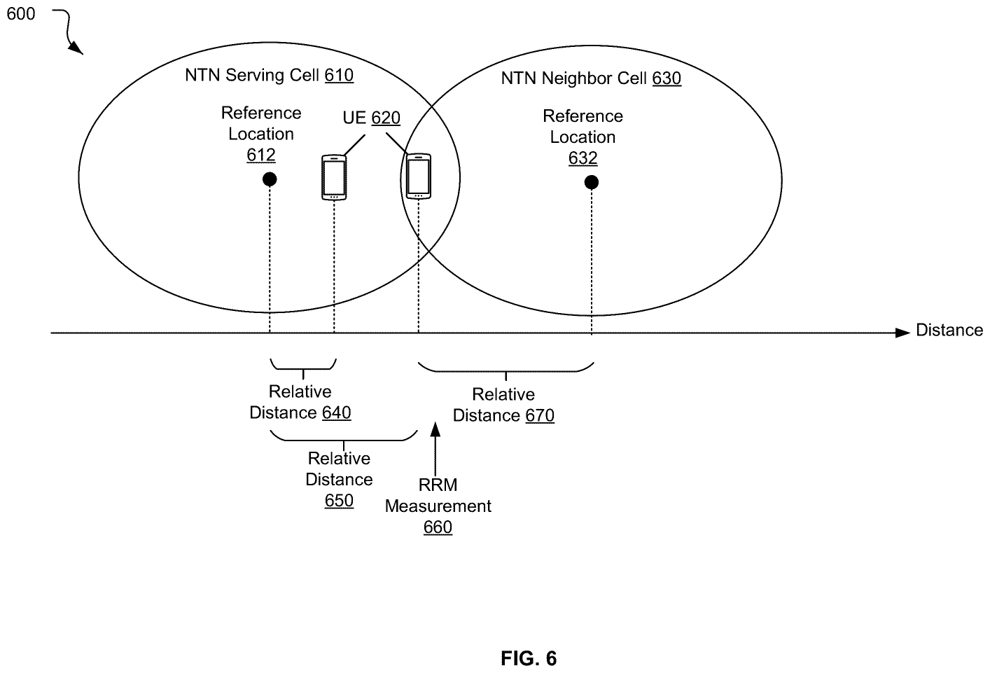

FIG. 6 illustrates a location-based RRM measurement 600 in accordance with some embodiments. As illustrated, a UE 620 is connected to an NTN serving cell 610 of an NTN node (e.g., an NTN eNB implemented on a satellite) such that the UE 620 has NTN coverage. The NTN serving cell 610 can move relative to the UE 620 and/or the UE 620 can move relative to the NTN 610. In both cases, the NTN coverage changes over time. The NTN service cell 610 can be associated with a reference location 612. When the relative distance between the UE 620 and the reference location 612 becomes large (e.g., exceeding a predetermined threshold), the UE 620 may start performing an RRM measurement. Generally, the relative distance at which the UE 620 can start performing the RRM measurement corresponds to a margin distance to the edge of the NTN serving cell 610, where this margin distance can correspond to the predetermined threshold. In other words, when the UE 620 is far enough from the reference location 612 and close enough to the edge of the NTN serving cell 610 (yet still within its boundaries), the UE 620 can perform the RRM measurement.

In certain situations, a neighbor cell may exist (such as an NTN neighbor cell 630 in the illustration of FIG. 3). Here also, the neighbor cell can move relative to the UE 620 (in the case of the NTN neighbor cell 630) and/or the UE 620 can move relative to the neighbor cell. The neighbor cell can be associated with a reference location too (shown as reference location 632 for the NTN neighbor cell 630). The relative distance between the UE 620 and this reference location can indicate whether network coverage of the neighbor cell to the UE 620 is possible. In case it is possible, the RRM measurement at least for the neighbor cell can be performed. Otherwise, this RRM measurement can be skipped. In other words, rather than performing the RRM measurement depending on only the relative distance between the UE 620 and the reference location 612 of the NTN serving cell 610, performing the RRM measurement can also be made dependent on the relative distance between the UE 620 and the reference location of the neighbor cell such that the RRM measurement can be skipped when unnecessary (e.g., when no coverage of the neighbor would be available to the UE 620).

In some embodiments, for quasi-Earth fixed satellite, the UE 620 starts performing neighbor NTN/TN cell RRM measurement when the relative distance between UE and referenceLocation of serving satellite is larger (or smaller depending on the physical meaning of referenceLocation) than a threshold.

In some embodiments, the network may provision the reference location(s) (referenceLocation) of the serving cell and/or neighbor cell in quasi-Earth fixed satellite. For example, one or more SIB messages can be used to configure the values of these reference locations for the UE 620.

The UE 620 may start the neighbor cell measurement when the UE 620 moves to a place where the relative distance between its location to the reference location is larger than a first threshold. In the illustration of FIG. 6, at a first time, the UE 620 is at a first location within the NTN serving cell 610. The UE 620 determines a first relative distance 640 between the UE 620 and the reference location 612, referred to as “referenceLocation1,” (e.g., the distance difference between the first distance and the referenceLocation1 which can be set in a SIB message). The UE 620 can compare the first relative distance 640 to the first threshold, referred to as “distance ThreshFromReference I” which can also be set in a SIB message. In the illustration of FIG. 6, the comparison indicates that the first relative distance 640 is smaller than the first threshold. Thus, the UE 620 does not start performing an RRM measurement.

At a second time, the UE 620 is at a second location within the NTN serving cell 610. The UE 620 determines a second relative distance 650 between the UE 620 and the reference location 612. The UE 620 can compare the second relative distance 650 to the first threshold. In the illustration of FIG. 6, the comparison indicates that the second relative distance 650 is larger than the first threshold. Accordingly, the UE 620 can start performing an RRM measurement 660.

In also the illustration of FIG. 6, the UE 620 may decide which neighbor NTN cell to measure based on the reference location configuration of neighbor satellites in SIB messages (e.g., one or more SIB3-NB messages). Here, the UE 620 can determine the reference location 632 of the NTN service cell 630, referred to as “referenceLocation2.” The UE 620 determines a third relative distance 670 between the UE 620 referenceLocation2. The UE 620 can compare the third relative distance 670 to a second threshold, referred to as “distance ThreshFromReference2” which can also be set in a SIB message. In the illustration of FIG. 6, the comparison indicates that the third relative distance 670 is smaller than the second threshold. Thus, the UE 620 can start performing the RRM measurement 660. Otherwise, the UE 620 can determine that no NTN neighbor cell is available and, accordingly, may skip the RRM measurement 660.

The UE 620 may also decide which TN cell and/or frequency to measure based on the configured frequencies and/or cells. Such configuration information can also be available from SIB messages including, for example, one or more SIB4-NB messages usable for indicating intra-frequency neighbor cell measurements and/or one or more SIB5-NB messages usable for indicating inter-frequency neighbor cell measurements.

In some embodiments, the UE 502 may start performing neighbor NTN/TN cell measurement when conditions, additional to the location-based condition described herein above, are met. These conditions may include: a channel quality of the NTN serving cell 610 being smaller than a predetermined threshold (e.g., as in the second condition discussed in FIG. 2) and a channel quality variance is fast (e.g., as in the first condition discussed in FIG. 2), in addition to determining that the UE 620 is moving to the edge of NTN serving cell 610 based on reference location information (as discussed above in FIG. 6).

Some embodiments may include enhancements for Earth moving cell in which the reference location is constantly changing. For example, the UE 620 can compute a relative distance between its location and the reference location by tracking both locations in a same coordinate system.

The timing-based and location-based RRM measurements of FIGS. 5 and 6 are illustrated as possibly being two separate and independent approaches. However, it may be possible to use these approaches in combination. In particular, when the two conditions of FIG. 5 (e.g., t-service is approaching) and FIG. 6 (the distance to a reference location is large), the RRM measurement can be performed.

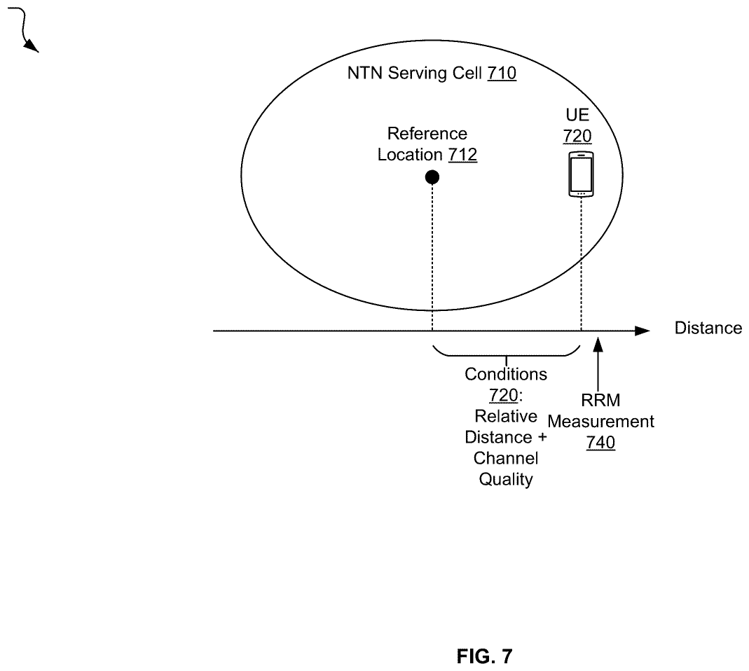

FIG. 7 illustrates a network coverage hole-based RRM measurement 700 in accordance with some embodiments. As illustrated, a UE 720 is connected to an NTN serving cell 710 of an NTN node (e.g., an NTN eNB implemented on a satellite) such that the UE 720 has NTN coverage. The NTN serving cell 710 can move relative to the UE 720 and/or the UE 720 can move relative to the NTN 710. In both cases, the NTN coverage changes over time. In certain situations, a coverage hole can occur. For example, the UE 720 may still be within the NTN serving cell 710, but the channel quality of the NTN serving cell 710 is low (e.g., the UE's 720 NRSRP measurement and/or some measurement of the NTN serving cell 710 is smaller than a threshold, such as smaller than s-MeasureIntra or s-MeasureInter), even when the UE 720 is not close to the edge of the NTN serving cell 710 (e.g., the relative distance between the UE 720 and a reference location 712 of the NTN serving cell is less than a threshold, such as referenceLocation is smaller than distance ThreshFromReference). In such situations, it may be expected that the channel quality may improve over time and that, possibly, no other neighbor cell may be available. As such, performing an RRM measurement when the UE 720 is in a coverage hole may be wasteful. Instead, the UE 720 may skip performing the RRM measurement, unless a set of conditions is satisfied.

In one example, the set of conditions relates to the channel quality and the relative distance. This set is illustrated in FIG. 7 as conditions 730. In particular, the UE 720 can determine the relative distance between the UE 720 and the reference location 712 and can determine the channel quality (e.g., based on an NRSRP measurement and/or some measurement of the NTN serving cell 710). If the relative distance is larger than a first predetermined threshold (e.g., distance ThreshFromReference) and if the channel quality is lower that a second predetermined threshold (e.g., s-MeasureIntra or s-MeasureInter), then the UE 720 performs an RRM measurement 740 (e.g., an intra-frequency measurement or an inter-frequency measurement as the case may be). Otherwise, the RRM measurement 740 is not performed. Here, the network can configure the thresholds. For example, one or more SIB messages are used to indicate the values of these thresholds.

In another example, a timer relaxation can be configured by the network (e.g., via SIB messages) or predefined in a technical specification. The timer relaxation can relax (e.g., increase) the time duration during which the UE 720 is allowed not perform an RRM measurement when the channel quality is low (e.g., smaller than the second predetermined threshold), the variation of the channel quality is fast, and/or the relative distance is small (e.g., smaller than the first predetermined threshold). Referring back to FIG. 2, the timer T310 can be configured to be relatively long for the UE 720 (e.g., relatively longer to what is shown in FIG. 2) to let the UE 720 recover from the coverage hole (e.g., not declaring RLF).

As such, in some instances, a coverage hole may exist in which a serving cell's channel quality is low, but the UE 720 is not at the NTN cell edge. If the UE 720 is located in a coverage hole, it may be desirable to avoid fast RRC re-establishment as there may not be other available satellites nearby for the UE 720 to access.

In some embodiments, a serving cell channel quality threshold may be jointly used with a referenceLocation as discussed elsewhere herein. The network may configure the UE 720 with both serving cell channel quality threshold and referenceLocation. The UE 720 may start RRM measurement on neighbor NTN/TN cells when both conditions are met (e.g., the serving cell channel quality is smaller than the serving cell channel quality threshold and the reference location is larger than a distance ThreshFromReference).

In some embodiments, a relatively long T310 may be configured to the UE 720 to let the UE 720 recover from a coverage hole (e.g., not declaring RLF).

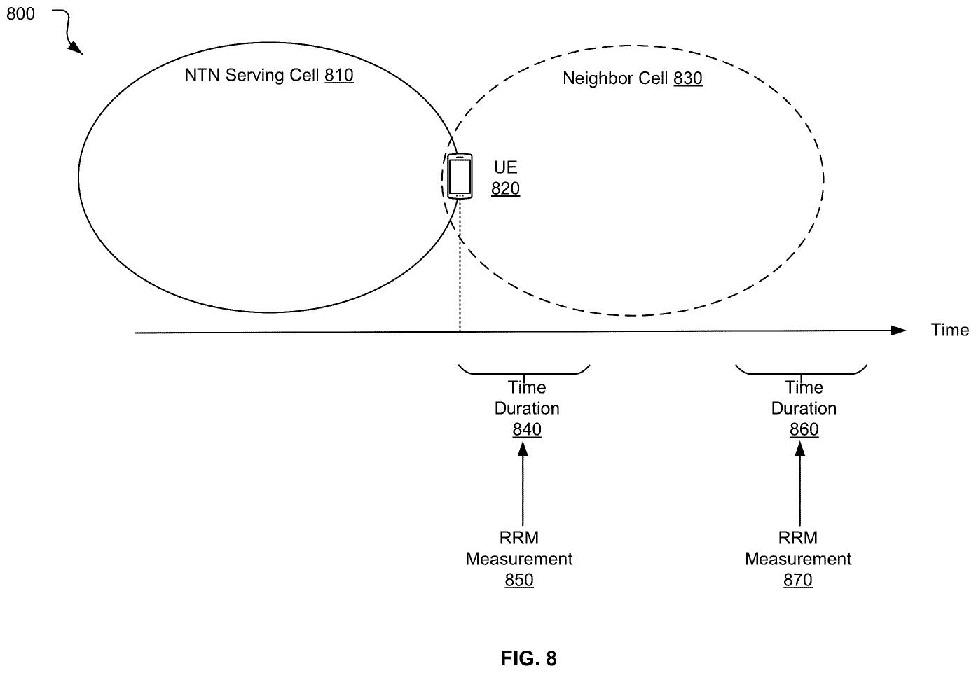

FIG. 8 illustrates a timer-based RRM measurement in accordance with some embodiments. As illustrated, a UE 820 is connected to an NTN serving cell 710 of an NTN node (e.g., an NTN eNB implemented on a satellite) such that the UE 820 has NTN coverage. The NTN serving cell 810 can move relative to the UE 820 and/or the UE 820 can move relative to the NTN 810. In both cases, the NTN coverage changes over time. In certain situations, a neighbor cell 820 (e.g., an NTN neighbor cell or a TN neighbor cell) may be unavailable for the UE 820 (shown in FIG. 8 with a dashed line to indicate the unavailability). If the UE 820 is near or at the edge of the NTN serving cell 810 and there is no available neighbor cell, it may be desirable to avoid a long RRM because performing an RRM measurement for a long time duration may be unnecessary or unbeneficial. The long RRM can be avoided by using a T3XX (e.g., T326) timer. However, such a timer is only applied when neighborCellMeasCriteria is configured by the network and this configuration is optional. Hence, in certain situations, the neighborCellMeasCriteria parameter is not configured and, as a result, the length of time of how long UE should perform an RRM measurement is undefined.

Embodiments can address this timer indefiniteness. In particular, the embodiments provide that when the neighborCellMeasCriteria parameter is not configured, the UE 820 performs connected RRM measurement for a limited time duration. The network may configure the time duration (which can be different than T3XX or T326) to the UE 820. In this case, one or more SIB messages can be used for the configuration. Alternatively, or additionally, the UE 820 may determine the time duration by itself. Alternatively, or additionally, the time duration may be defined in a technical specification with which the UE 820 is compatible.

If the UE 820 cannot find a neighbor cell when the timer (as above) expires, the UE 840 may stop the RRM measurement. When the UE 840 re-starts RRM measurement (e.g., the next RRM measurement) may be an implementation specific to the UE 820. For example, this implementation can be based on ephemeris data of satellites. In particular, the ephemeris data can be received in one or more SIB data and can indicate a position, movement, and/or an orbit of the serving satellite. Accordingly, the UE 820 can estimate the time at which the next NTN coverage may start. The re-start time can be set based on this estimated time (e.g., to coincide with, be shortly before (such as one hundred milliseconds before), or be shortly after the estimated time (such as one hundred milliseconds after)).

In the illustration of FIG. 8, the UE 820 is at the edge of the NTN serving cell 810 (although the embodiments can similarly and equivalently apply when the relative distance between the UE 820 and a reference location of the NTN serving cell 810 is larger than a threshold as in FIG. 6 or 7). The UE 820 can start performing an RRM measurement 850, where this performance lasts for a time duration 840 configured by the network (as a different timer than T3XX or T326), implemented by the UE 820, or specified in a technical specification. After the end of the time window 840, the UE 820 stops the performance. The UE 820 can then determine a re-start point in time for a next RRM measurement 870 (e.g., based on ephemeris data). When the re-start point in time, the UE performs the next RM measurement 870 during a next time window 860, which can have the same length as the time window 840 by having the same configuration.

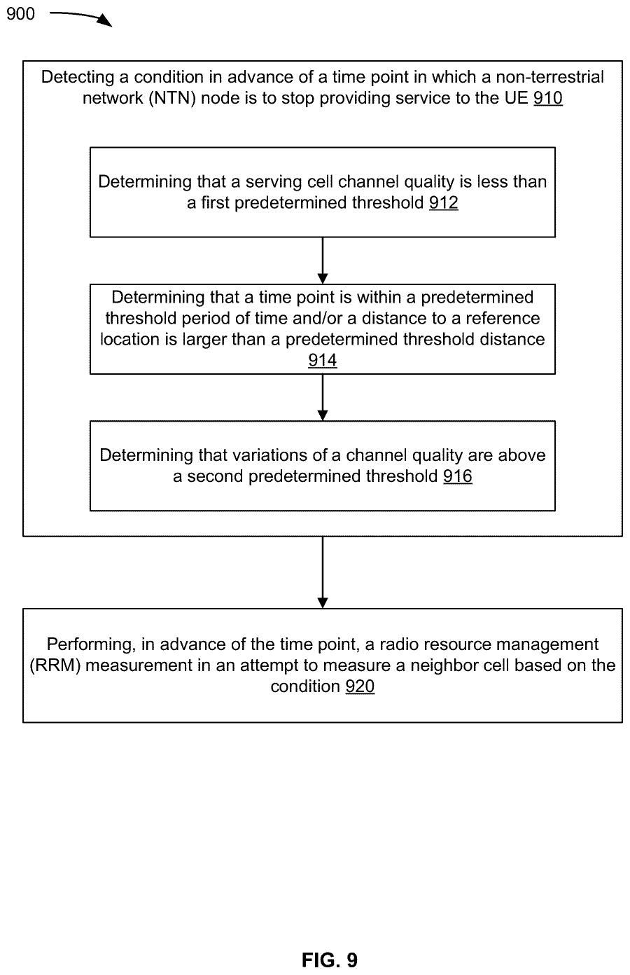

FIG. 9 illustrates an example of an operational flow/algorithmic structure implemented for managing performance of RRM measurement, in accordance with some embodiments. The operation flow/algorithmic structure 900 may be performed or implemented by a UE such as any of the UEs described herein above, or components thereof, for example, processors 1004.

The operation flow/algorithmic structure 900 may include, at 910, detecting a condition in advance of a time point in which a non-terrestrial network (NTN) node is to stop providing service to the UE. The condition can be a timing-based condition related to, for example, t-service, as described in FIG. 5, a location-based condition related to, for example, a reference location, as described in FIG. 6, a coverage hole as described in FIG. 7, and/or a timer condition as described in FIG. 8. Additional conditions can also be detected. As illustrated in FIG. 9, operation 902 can include multiple sub-operations 912-916. For example, the operation flow/algorithmic structure 900 may include, at 912, determining that a serving cell channel quality is less than a first predetermined threshold. The serving cell channel quality can be an NRSRP measurement. The first predetermined threshold can be s-MeasureIntra or s-MeasureInter. The operation flow/algorithmic structure 900 may also include, at 914, determining that a time point is within a predetermined threshold period of time and/or a distance to a reference location is larger than a predetermined threshold distance. The time point can be defined relative to t-service as described in FIG. 5. The distance can be a relative distance as described in FIG. 6. The operation flow/algorithmic structure 900 may also include, at 916, determining that that variations of a channel quality are above a second predetermined threshold. The second predetermined threshold can be s-MeasureDeltaP.

The operation flow/algorithmic structure 900 may include, at 910, performing, in advance of the time point, RRM measurement in an attempt to measure a neighbor cell based on the condition. The neighbor cell can be an NTN neighbor cell or a TN neighbor cell. The RRM measurement can include an inter-frequency measurement and/or an intra-frequency measurement.

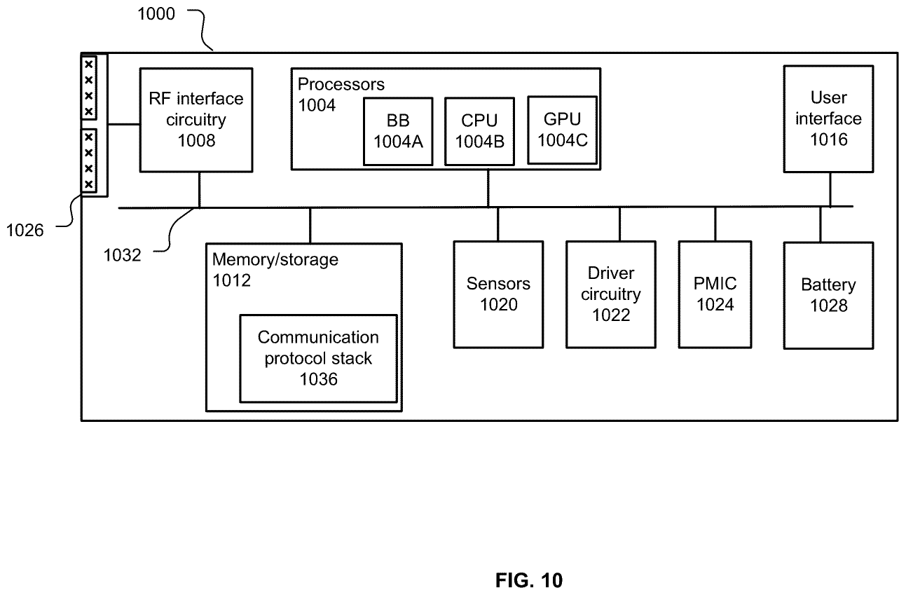

FIG. 10 illustrates an example UE 1000 in accordance with some embodiments. The UE 1000 may correspond to any of the UEs described herein above and may be any mobile or non-mobile computing device, such as, for example, a mobile phone, a computer, a tablet, an industrial wireless sensor (for example, a microphone, a carbon dioxide sensor, a pressure sensor, a humidity sensor, a thermometer, a motion sensor, an accelerometer, a laser scanner, a fluid level sensor, an inventory sensor, an electric voltage/current meter, or an actuators), a video surveillance/monitoring device (for example, a camera), a wearable device (for example, a smart watch), or an Internet-of-things (IoT) device.

The UE 1000 may include processors 1004, RF interface circuitry 1008, memory/storage 1012, user interface 1016, sensors 1020, driver circuitry 1022, power management integrated circuit (PMIC) 1024, antenna structure 1026, and battery 1028. The components of the UE 1000 may be implemented as integrated circuits (ICs), portions thereof, discrete electronic devices, or other modules, logic, hardware, software, firmware, or a combination thereof. The block diagram of FIG. 10 is intended to show a high-level view of some of the components of the UE 1000. However, some of the components shown may be omitted, additional components may be present, and different arrangement of the components shown may occur in other implementations.

The components of the UE 1000 may be coupled with various other components over one or more interconnects 1032, which may represent any type of interface, input/output, bus (local, system, or expansion), transmission line, trace, optical connection, etc. that allows various circuit components (on common or different chips or chipsets) to interact with one another.

The processors 1004 may include processor circuitry such as, for example, baseband processor circuitry (BB) 1004A, central processor unit circuitry (CPU) 1004B, and graphics processor unit circuitry (GPU) 1004C. The processors 1004 may include any type of circuitry or processor circuitry that executes or otherwise operates computer-executable instructions, such as program code, software modules, or functional processes from memory/storage 1012 to cause the UE 1000 to perform operations as described herein.

In some embodiments, the baseband processor circuitry 1004A may access a communication protocol stack 1036 in the memory/storage 1012 to communicate over a 3GPP compatible network. In general, the baseband processor circuitry 1004A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 1008.

The baseband processor circuitry 1004A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1012 may include one or more non-transitory, computer-readable media that includes instructions (for example, communication protocol stack 1036) that may be executed by one or more of the processors 1004 to cause the UE 1000 to perform various operations described herein. The memory/storage 1012 include any type of volatile or non-volatile memory that may be distributed throughout the UE 1000. In some embodiments, some of the memory/storage 1012 may be located on the processors 1004 themselves (for example, L1 and L2 cache), while other memory/storage 1012 is external to the processors 1004 but accessible thereto via a memory interface. The memory/storage 1012 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1008 may include transceiver circuitry and radio frequency front module (RFEM) that allows the UE 1000 to communicate with other devices over a radio access network. The RF interface circuitry 1008 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1026 and proceed to filter and amplify (with a low-noise amplifier) the signal. The signal may be provided to a receiver of the transceiver that down-converts the RF signal into a baseband signal that is provided to the baseband processor of the processors 1004.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1026.

In various embodiments, the RF interface circuitry 1008 may be configured to transmit/receive signals in a manner compatible with NR access technologies.

The antenna 1026 may include antenna elements to convert electrical signals into radio waves to travel through the air and to convert received radio waves into electrical signals. The antenna elements may be arranged into one or more antenna panels. The antenna 1026 may have antenna panels that are omnidirectional, directional, or a combination thereof to enable beamforming and multiple-input, multiple-output communications. The antenna 1026 may include microstrip antennas, printed antennas fabricated on the surface of one or more printed circuit boards, patch antennas, phased array antennas, etc. The antenna 1026 may have one or more panels designed for specific frequency bands including bands in FRI or FR2.

The user interface circuitry 1016 includes various input/output (I/O) devices designed to enable user interaction with the UE 1000. The user interface 1016 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1000.

The sensors 1020 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1022 may include software and hardware elements that operate to control particular devices that are embedded in the UE 1000, attached to the UE 1000, or otherwise communicatively coupled with the UE 1000. The driver circuitry 1022 may include individual drivers allowing other components to interact with or control various input/output (I/O) devices that may be present within, or connected to, the UE 1000. For example, driver circuitry 1022 may include a display driver to control and allow access to a display device, a touchscreen driver to control and allow access to a touchscreen interface, sensor drivers to obtain sensor readings of sensor circuitry 1020 and control and allow access to sensor circuitry 1020, drivers to obtain actuator positions of electro-mechanic components or control and allow access to the electro-mechanic components, a camera driver to control and allow access to an embedded image capture device, audio drivers to control and allow access to one or more audio devices.

The PMIC 1024 may manage power provided to various components of the UE 1000. In particular, with respect to the processors 1004, the PMIC 1024 may control power-source selection, voltage scaling, battery charging, or DC-to-DC conversion.

In some embodiments, the PMIC 1024 may control, or otherwise be part of, various power saving mechanisms of the UE 1000. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1000 may power down for brief intervals of time and thus save power. If there is no data traffic activity for an extended period of time, then the UE 1000 may transition off to an RRC_Idle state, where it disconnects from the network and does not perform operations such as channel quality feedback, handover, etc. The UE 1000 goes into a very low power state, and it performs paging where again it periodically wakes up to listen to the network and then powers down again. The UE 1000 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1028 may power the UE 1000, although in some examples the UE 1000 may be mounted deployed in a fixed location and may have a power supply coupled to an electrical grid. The battery 1028 may be a lithium ion battery, a metal-air battery, such as a zinc-air battery, an aluminum-air battery, a lithium-air battery, and the like. In some implementations, such as in vehicle-based applications, the battery 1028 may be a typical lead-acid automotive battery.

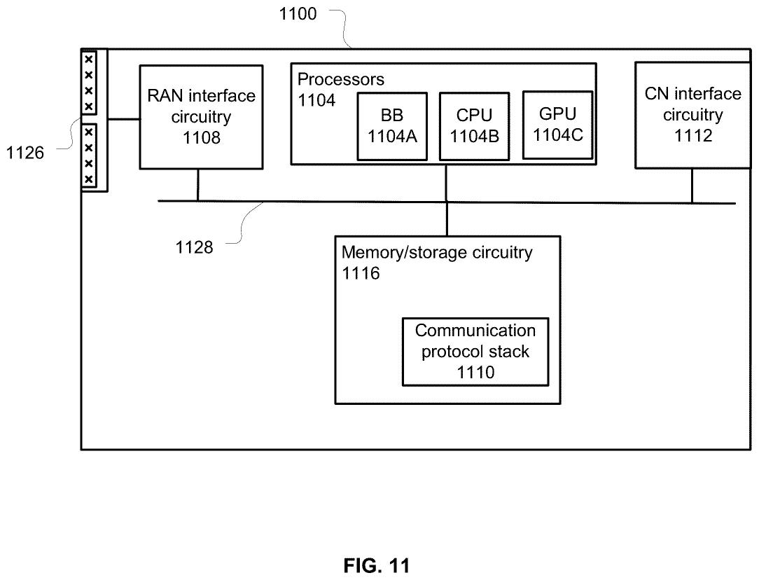

FIG. 11 illustrates an example base station 1100 in accordance with some embodiments. The base station 1100 may be a base station as described elsewhere herein. The base station 1100 may include processors 1104, RF interface circuitry 1108, core network (CN) interface circuitry 1112, memory/storage circuitry 1116, and antenna structure 1126. The RF interface circuitry 1108 and antenna structure 1126 may not be included when the base station 1100 is an AMF.

The components of the base station 1100 may be coupled with various other components over one or more interconnects 1128.

The processors 1104, RF interface circuitry 1108, memory/storage circuitry 1116 (including communication protocol stack 1110), antenna structure 1126, and interconnects 1128 may be similar to like-named elements shown and described with respect to FIG. 10.

The CN interface circuitry 1112 may provide connectivity to a core network, for example, a 4th or 5th Generation Core network (4/5GC) using a 4/5GC-compatible network interface protocol such as carrier Ethernet protocols, or some other suitable protocol. Network connectivity may be provided to/from the base station 1100 via a fiber optic or wireless backhaul. The CN interface circuitry 1112 may include one or more dedicated processors or FPGAs to communicate using one or more of the aforementioned protocols. In some implementations, the CN interface circuitry 1112 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

In the following sections, further exemplary embodiments are provided.

Example 1 includes a method of operating a user equipment (UE), the method comprising: detecting a condition in advance of a time point in which a non-terrestrial network (NTN) node is to stop providing service to the UE; and performing, in advance of the time point, a radio resource management (RRM) measurement in an attempt to measure a neighbor cell based on the condition.

Example 2 includes the method of example 1 or some other example herein, further comprising: receiving, from a network, an indication of the time point or a time window that encompasses the time point.

Example 3 includes the method of example 1 or some other example herein of claim 1, wherein the neighbor cell is an NTN neighbor cell and the method further comprises: receiving a system information block (SIB) 32 message; and selecting the neighbor cell based on the SIB 32 message.

Example 4 includes the method of example 3 or some other example herein, further comprising: selecting the neighbor cell based on ephemeris orbital parameters or a t-service indication in the SIB 32 message.

Example 5 includes the method of example 1 or some other example herein, wherein the neighbor cell is a terrestrial network (TN) neighbor cell and the method further comprises: receiving a system information block (SIB) 4 or SIB 5 message; and selecting the neighbor cell based on the SIB 4 or SIB 5 message.

Example 6 includes a method of example 5 or some other example herein, further comprising: selecting the neighbor cell based on configured frequencies in the SIB 4 or SIB 5 message.

Example 7 includes the method of example 1 or some other example herein, wherein detecting the condition comprises: determining that a serving cell channel quality is less than a first predetermined threshold; determining that the time point is within a predetermined threshold period of time; and determining that variations of a channel quality are above a second predetermined threshold.

Example 8 includes the method of example 1 or some other example herein, further comprising: selecting the neighbor cell based on prioritization information provided by the network.

Example 9 includes the method of example 1 or some other example herein, wherein the UE is a narrowband Internet-of-things UE.

Example 10 includes the method of example 1 or some other example herein, wherein detecting the condition comprises: determining a reference location of a serving satellite; and comparing a relative distance between the UE and the reference location.

Example 11 includes the method of example 10 or some other example herein, further comprising: receiving an indication of the reference location from a network.

Example 12 includes the method of example 10 or 11 or some other example herein, wherein detecting the condition further comprises: determining that the first distance is larger than the first predetermined threshold; and determining that a second distance between the UE and a second reference location of the neighbor cell of the NTN is smaller than a second predetermined threshold.

Example 13 includes the method of example 10, 11, or 12 or some other example herein, wherein detecting the condition further comprises: determining that a serving cell channel quality is less than a third predetermined threshold; and determining that variations of a channel quality are above a predetermined threshold.

Example 14 includes the method of example 10 or some other example herein, wherein detecting the condition further comprises: determining that the first distance is larger than the first predetermined threshold; and determining that a serving cell channel quality is less than a second predetermined threshold.

Example 15 includes the method of example 1 or some other example herein, further comprising: selecting the neighbor cell based on a reference location configuration in a SIB-3 message.

Example 16 includes the method of example 1 or some other example herein, further comprising: determining a neighbor cell measurement criteria parameter is not configured; detecting a time duration based on said determining the neighbor cell measurement criteria is not configured; and limiting said performing of the RRM measurement to the time duration.

Example 17 includes the method of example 16 or some other example herein, further comprising: determining the time duration based on a network configuration or a predefined UE configuration.

Example 18 may include an apparatus comprising means to perform one or more elements of a method described in or related to any of examples 1-17, or any other method or process described herein.

Example 19 may include one or more non-transitory computer-readable media comprising instructions to cause an electronic device, upon execution of the instructions by one or more processors of the electronic device, to perform one or more elements of a method described in or related to any of examples 1-17, or any other method or process described herein.

Example 20 may include an apparatus comprising logic, modules, or circuitry to perform one or more elements of a method described in or related to any of examples 1-17, or any other method or process described herein.

Example 21 may include a method, technique, or process as described in or related to any of examples 1-17, or portions or parts thereof.

Example 22 may include an apparatus, such as a UE, comprising: one or more processors and one or more memory (e.g., one or more computer-readable media) comprising instructions that, when executed by the one or more processors, cause the one or more processors to perform the method, techniques, or process as described in or related to any of examples 1-17, or portions thereof.

Example 23 may include a signal as described in or related to any of examples 1-17, or portions or parts thereof.

Example 24 may include a datagram, information element, packet, frame, segment, PDU, or message as described in or related to any of examples 1-17, or portions or parts thereof, or otherwise described in the present disclosure.

Example 25 may include a signal encoded with data as described in or related to any of examples 1-17, or portions or parts thereof, or otherwise described in the present disclosure.

Example 26 may include a signal encoded with a datagram, IE, packet, frame, segment, PDU, or message as described in or related to any of examples 1-17, or portions or parts thereof, or otherwise described in the present disclosure.

Example 27 may include an electromagnetic signal carrying computer-readable instructions, wherein execution of the computer-readable instructions by one or more processors is to cause the one or more processors to perform the method, techniques, or process as described in or related to any of examples 1-17, or portions thereof.

Example 28 may include a computer program comprising instructions, wherein execution of the program by a processing element is to cause the processing element to carry out the method, techniques, or process as described in or related to any of examples 1-17, or portions thereof.

Example 29 may include a signal in a wireless network as shown and described herein.

Example 30 may include a method of communicating in a wireless network as shown and described herein.

Example 31 may include a system for providing wireless communication as shown and described herein.

Example 32 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1.-20. (canceled)

21. A method comprising:
detecting a condition in advance of a time point in which a non-terrestrial network (NTN) node is to stop providing service to a user equipment (UE); and
performing, in advance of the time point, a radio resource management (RRM) measurement in an attempt to measure a neighbor cell based on the condition.

22. The method of claim 21, further comprising:
processing an indication of the time point or a time window that encompasses the time point, the indication received from the NTN node.

23. The method of claim 21, wherein the neighbor cell is an NTN neighbor cell and the method further comprises:
processing a system information block (SIB) 32 message; and
selecting the neighbor cell based on the SIB 32 message.

24. The method of claim 23, further comprising:
selecting the neighbor cell based on ephemeris orbital parameters or a t-service indication in the SIB 32 message.

25. The method of claim 21, wherein the neighbor cell is a terrestrial network (TN) neighbor cell and the method further comprises:
processing a system information block (SIB) 4 or SIB 5 message; and
selecting the neighbor cell based on the SIB 4 or SIB 5 message.

26. The method of claim 25, further comprising:
selecting the neighbor cell based on configured frequencies in the SIB 4 or SIB 5 message.

27. The method of claim 21, wherein detecting the condition comprises:
determining that a serving cell channel quality is less than a first predetermined threshold;
determining that the time point is within a predetermined threshold period of time; and
determining that variations of a channel quality are above a second predetermined threshold.

28. The method of claim 21, further comprising:
selecting the neighbor cell based on prioritization information provided by a network.

29. The method of claim 21, wherein the UE is a narrowband Internet-of-things UE.

30. The method of claim 21, wherein detecting the condition comprises:
determining a first reference location of a serving cell of the NTN; and
comparing a first distance between the UE and the first reference location with a first predetermined threshold.

31. The method of claim 30, further comprising:
processing an indication of the first reference location from a network.

32. The method of claim 30, wherein detecting the condition further comprises:
determining that the first distance is larger than the first predetermined threshold; and
determining that a second distance between the UE and a second reference location of the neighbor cell of the NTN is smaller than a second predetermined threshold.

33. The method of claim 30, wherein detecting the condition comprises:
determining that a serving cell channel quality is less than a third predetermined threshold; and
determining that variations of a channel quality are above a predetermined threshold.

34. The method of claim 30, wherein detecting the condition comprises:
determining that the first distance is larger than the first predetermined threshold; and
determining that a serving cell channel quality is less than a second predetermined threshold.

35. The method of claim 33, further comprising:
selecting the neighbor cell based on a reference location configuration in a system information block (SIB) 3 message.

36. The method of claim 21, further comprising:
determining a neighbor cell measurement criteria parameter is not configured;
detecting a time duration based on said determining the neighbor cell measurement criteria parameter is not configured; and
limiting said performing of the RRM measurement to the time duration.

37. The method of claim 36, further comprising:
determining the time duration based on a network configuration or a predefined UE configuration.

38. The method of claim 36, further comprising:
stopping the RRM measurement at an end of the time duration;
determining a re-start time based on ephemeris data associated with the NTN; and
re-starting the RRM measurement at the re-start time.

39. An apparatus comprising:
processing circuitry configured to:
detect a condition in advance of a time point in which a non-terrestrial network (NTN) node is to stop providing service to a user equipment (UE); and
perform, in advance of the time point, a radio resource management (RRM) measurement in an attempt to measure a neighbor cell based on the condition; and
interface circuity coupled with the processing circuitry to enable communication.

40. One or more computer-readable storage media storing instructions that, upon execution, cause operations comprising:
detecting a condition in advance of a time point in which a non-terrestrial network (NTN) node is to stop providing service to a user equipment (UE); and
performing, in advance of the time point, a radio resource management (RRM) measurement in an attempt to measure a neighbor cell based on the condition.
